(19) United States
(12) Patent Application Publication
(10) Pub. No.: US 2025/0053874 A1
(43) Pub. Date: Feb. 13, 2025

(54) METHOD AND APPARATUS FOR SEQUENTIAL LEARNING OF TWO-SIDED ARTIFICIAL INTELLIGENCE/MACHINE LEARNING MODEL FOR FEEDBACK OF CHANNEL STATE INFORMATION IN COMMUNICATION SYSTEM

(71) Applicant: Electronics and Telecommunications Research Institute, Daejeon (KR)

(72) Inventors: Anseok LEE, Daejeon (KR); Heesoo LEE, Daejeon (KR); Yong Jin KWON, Daejeon (KR); Seungjae BAHNG, Daejeon (KR); Yunjoo KIM, Daejeon (KR); Hyun Seo PARK, Daejeon (KR); Jungbo SON, Daejeon (KR); Yu Ro LEE, Daejeon (KR)

(21) Appl. No.: 18/799,222

(22) Filed: Aug. 9, 2024

(30) Foreign Application Priority Data
Aug. 10, 2023 (KR) 10-2023-0105108
Aug. 9, 2024 (KR) 10-2024-01006505

(51) Int. Cl. G06N 20/00; H04B 7/06

(52) U.S. Cl. CPC G06N 20/00; H04B 7/0626

(57) ABSTRACT

A method of a first training node may comprise: performing training on a first two-sided AI/ML model using a raw training data set collected for CSI feedback; generating a sequential training data set for sequential training on the first two-sided AI/ML model; performing pruning on the sequential training data set to obtain a reduced sequential training data set; and transmitting, to a second training node, two-sided AI/ML training data information including at least one of the reduced sequential training data set or sequential training data configuration information.

### CROSS-REFERENCE TO RELATED APPLICATIONS

This application claims priority to Korean Patent Applications No. 10-2023-0105108, filed on Aug. 10, 2023, and No. 10-2024-0106505, filed on Aug. 9, 2024, with the Korean Intellectual Property Office (KIPO), the entire contents of which are hereby incorporated by reference.

### BACKGROUND

### 1. Technical Field

The present disclosure relates to a technique for training an artificial intelligence (AI)/machine learning (ML) model in a communication system, and more particularly, to a sequential learning technique for two-sided AI/ML model for channel state information feedback.

### 2. Related Art

With the development of information and communication technology, various wireless communication technologies have been developed. Typical wireless communication technologies include long term evolution (LTE) and new radio (NR), which are defined in the 3rd generation partnership project (3GPP) standards. The LTE may be one of 4th generation (4G) wireless communication technologies, and the NR may be one of 5th generation (5G) wireless communication technologies.

For the processing of rapidly increasing wireless data after the commercialization of the 4th generation (4G) communication system (e.g. Long Term Evolution (LTE) communication system or LTE-Advanced (LTE-A) communication system), the 5th generation (5G) communication system (e.g. new radio (NR) communication system) that uses a frequency band (e.g. a frequency band of 6 GHz or above) higher than that of the 4G communication system as well as a frequency band of the 4G communication system (e.g. a frequency band of 6 GHz or below) is being considered. The 5G communication system may support enhanced Mobile BroadBand (eMBB), Ultra-Reliable and Low-Latency Communication (URLLC), and massive Machine Type Communication (mMTC).

Recently, there has been active research on applying artificial intelligence (AI) and machine learning (ML) technologies in mobile communications. Approaches for enhancing the performance of feedback processes, such as channel state information (CSI) feedback, based on AI/ML are being explored. In the case of a two-sided ML model for CSI feedback, technologies may be required to ensure that inference is carried out jointly by models present on both the terminal and the base station sides.

### SUMMARY

The present disclosure for resolving the above-described problems is directed to providing a method and an apparatus for sequential training on a two-sided AI/ML model for channel state information feedback.

A method of a first training node, according to exemplary embodiments of the present disclosure for achieving the above-described objective, may comprise: performing training on a first two-sided artificial intelligence/machine learning (AI/ML) model using a raw training data set collected for channel state information (CSI) feedback; generating a sequential training data set for sequential training on the first two-sided AI/ML model; performing pruning on the sequential training data set to obtain a reduced sequential training data set; and transmitting, to a second training node, two-sided AI/ML training data information including at least one of the reduced sequential training data set or sequential training data configuration information, wherein the raw training data set includes multiple raw training data, the raw training data includes at least one of channel information, cell information, region information, or signal-to-noise ratio (SNR) information, each of the sequential training data set and the reduced sequential training data set includes multiple sequential training data, the sequential training data includes a pair of the channel information and mapping information for the channel information, and the channel information is a channel matrix or a precoding vector.

The first double-sided AI/ML model may include at least one of a first encoder model or a first decoder model, and when the first training node is a base station, the first encoder model may not be used in a CSI feedback operation, and the CSI feedback may correspond to inference in the first training node.

The sequential training data configuration information may include at least one of a number of samples of the raw training data, additional information of the raw training data, a number of samples of the sequential training data, a reduction ratio of a number of the sequential training data, a type of the channel information, whether or not the channel information is quantized and a quantization scheme of the channel information, a quantization scheme of the mapping information, or a performance value according to the model and training of the first training node.

The sequential training data configuration information may include information on a reduction scheme of the sequential training data, and the reduction scheme may include at least one of a random sampling-based reduction scheme, a density-based reduction scheme of channel information, a density-based reduction scheme of mapping information, or a model-based importance-driven reduction scheme.

The sequential training data configuration information may include at least one information of importance information or density information for each sample of the sequential training data for the sequential training, and the at least one information may be determined according to a scheme of reducing the sequential training data for the sequential training.

The method may further comprise: receiving, from the second training node, first indication information indicating that data augmentation has been applied, wherein the first indication information may include information related to a scheme applied to the data augmentation, the scheme is at least one of a noise-addition scheme, a rotation scheme, or a generative AI model scheme, and the scheme may be considered for training on the first double-sided AI/ML model.

When the second node is confirmed to have applied data augmentation according to the first indication information, the first training node may perform new training or additional training on the first double-sided AI/ML model by applying the scheme.

The method may further comprise, after the reduced sequential training data set is transferred to the second training node, generating a second reduced sequential training data set for additional training; and transmitting, to the second training node, second double-sided AI/ML training data information including at least one of the second reduced sequential training data set or second sequential training data configuration information, wherein the second sequential training data configuration information may include information indicating that the second reduced sequential training data set is used for additional training.

The method may further comprise: receiving, from the second training node, an additional training request requesting additional training; generating a second reduced sequential training data set based on the additional training request; and in response to the additional training request, transmitting, to the second training node, second double-sided AI/ML training data information including at least one of the second reduced sequential training data set or second sequential training data configuration information, wherein the additional training request may include at least one of a sample of channel information requiring additional training or a performance value of channel information requiring additional training, and the second sequential training data configuration information may include information indicating that the second reduced sequential training data set is used for additional training.

The method may further comprise: transmitting, to the second training node, double-sided AI/ML training data information including at least one of the sequential training data set or the sequential training data configuration information; and receiving, from the second learning node, mapping change indication information indicating that mapping information has been changed for the sequential training data set, wherein when a first performance according to a result of training the first double-sided AI/ML model is lower than a second performance according to a result of training a double-sided AI/ML model in the second training node, the change indication information may be received from the second training node, and training on the first double-sided AI/ML model may be performed using the sequential training data set.

The method may further comprise: transmitting, to the second training node, double-sided AI/ML training data information including at least one of the sequential training data set or the sequential training data configuration information; and receiving, from the second learning node, reduction scheme information indicating a reduction scheme applied to the sequential training data set, wherein the reduction scheme may include at least one of a random sampling-based reduction scheme, a density-based reduction scheme of channel information, a density-based reduction scheme of mapping information, or a model-based importance-driven reduction scheme.

A method of a second training node, according to exemplary embodiments of the present disclosure for achieving the above-described objective, may comprise: receiving, from a first training node, two-sided artificial intelligence/machine learning (AI/ML) training data information including a reduced sequential training data set; performing sequential training on a two-sided AI/ML model for channel state information (CSI) feedback using the reduced sequential training data set; and transmitting CSI feedback information to the first training node based on the two-sided AI/ML model, wherein the two-sided AI/ML model includes at least one of an encoder model and a decoder model, the reduced sequential training data set includes multiple sequential training data, each of the multiple sequential training data includes a pair of channel information and mapping information for the channel information, the channel information includes at least one sample, and the channel information is expressed as a channel matrix or a precoding vector.

The method may further comprise: in response to the second training node determining to apply data augmentation, transmitting, to the first training node, first indication information indicating that the data augmentation is applied, wherein the first double-sided AI/ML model may be trained by applying the data augmentation before the first indication information is transmitted to the first training node, the first indication information may include at least one of information indicating whether the data augmentation is applied in the second training node, information indicating that the second training node has determined the data augmentation, or information indicating a scheme applied to the data augmentation, and the scheme applied to the data augmentation may be at least one of a noise-addition scheme, a rotation scheme, or a scheme of using a generative AI model.

The method may further comprise: receiving, from the first training node, second double-sided AI/ML training data information including at least one of a second reduced sequential training data set for additional training or second sequential training data configuration information; and performing additional training on the double-sided AI/ML model using the second reduced sequential training data set, wherein the second sequential training configuration information may include information indicating that the second reduced sequential training data set is used for additional training.

The method may further comprise: transmitting, to the first training node, an additional training request requesting additional training on the double-sided AI/ML model; in response to the additional training request, receiving second double-sided AI/ML training data information including at least one of a second reduced sequential training data set or second sequential training configuration information; and performing the additional training on the double-sided AI/ML model using the second reduced sequential training data set, wherein the additional training request may include at least one of a sample of channel information requiring additional training or a performance value of channel information requiring additional training, and the second sequential training data configuration information may include information indicating that the second reduced sequential training data set is used for additional training.

The transmitting of the additional training request to the first training node may comprise: comparing a first performance of training the double-sided AI/ML model in the first training node with a second performance of training the double-sided AI/ML model in the second training node, wherein the additional training request may be transmitted to the first training node when the second performance is lower than the first performance.

The method may further comprise: receiving, from the first training node, double-sided AI/ML training data information including at least one of a sequential training data set or sequential training data configuration information; performing training on the double-sided AI/ML model using the sequential training data set; performing mapping information change on the sequential training data set according to a result of the training on the double-sided AI/ML model; and transmitting, to the first training node, mapping change indication information indicating that mapping information has been changed for the sequential training data set, wherein when a first performance is lower than a second performance, the mapping change indication information may be transmitted to the first training node, and the first performance may be a performance according to a result of training the double-sided AI/ML model in the first training node, and the second performance may be a performance according to a result of training the double-sided AI/ML model in the second training node.

The method may further comprise: receiving, from the first training node, double-sided AI/ML training data information including at least one of a sequential training data set or sequential training data configuration information; performing a reduction process on the sequential training data set to generate a reduced sequential training data set; performing second sequential training on the double-sided AI/ML model using the reduced sequential training data set; and transmitting, to the first training node, reduction scheme information indicating a reduction scheme applied to the sequential training data set, wherein the reduction scheme may include at least one of a random sampling-based reduction scheme, a density-based reduction scheme of channel information, a density-based reduction scheme of mapping information, or a model-based importance-based reduction scheme.

A first training node, according to exemplary embodiments of the present disclosure for achieving the above-described objective, may comprise at least one processor, and the at least one processor may cause the first training node to perform: performing training on a first two-sided artificial intelligence/machine learning (AI/ML) model using a raw training data set collected for channel state information (CSI) feedback; generating a sequential training data set for sequential training on the first two-sided AI/ML model; and transmitting the sequential training data set and information on the first two-sided AI/ML model to a second training node, wherein the information on the first two-sided AI/ML model may include at least one of encoder model-related information or decoder model-related information.

Information on the first two-sided AI/ML model may include at least one of a type of a backbone artificial neural network, a type of input data, a size of input data, a type of output data, a size of output data, amount of computation, a number of artificial neural network parameters, a size of storage space, a quantization scheme of artificial neural network parameters, artificial neural network parameters, training data identifier, or information related to performance of artificial neural networks.

According to exemplary embodiments of the present disclosure, provided is a sequential training method for an AI/ML model to perform CSI feedback in a communication system.

As the sequential training method for the AI/ML model, a training method using reduced sequential training data can be provided. The provided training method can facilitate sequential training. The reduced sequential training data may be configured by reducing the number of samples.

In the sequential training method for the AI/ML model, a first training node may configure full or partial information for the AI/ML model. The first training node may transfer the full or partial information for the AI/ML model to a second training node. The second training node can efficiently configure an AI/ML model using the full or partial information for the AI/ML model provided by the first training node.

### BRIEF DESCRIPTION OF DRAWINGS

FIG. 1 is a conceptual diagram illustrating an exemplary embodiment of a communication system.

FIG. 2 is a block diagram illustrating an exemplary embodiment of a communication node constituting a communication system.

FIG. 3 is a sequence chart illustrating a sequential training method of a double-sided AI/ML model for channel state information feedback according to exemplary embodiments of the present disclosure.

FIG. 4 is a conceptual diagram illustrating training data for sequential training of a double-sided AI/ML model according to exemplary embodiments of the present disclosure.

FIG. 5 is a sequence chart illustrating a sequential training method of a two-sided AI/ML model using data augmentation according to exemplary embodiments of the present disclosure.

FIG. 6 is a sequence chart illustrating an additional training method in a sequential training method of a double-sided AI/ML model according to exemplary embodiments of the present disclosure.

FIG. 7 is a sequence chart illustrating a double-sided AI/ML model information transmission method according to exemplary embodiments of the present disclosure.

FIG. 8 is a sequence chart illustrating a method for transmitting double-sided AI/ML model information based on a request according to exemplary embodiments of the present disclosure.

### DETAILED DESCRIPTION OF THE EMBODIMENTS

While the present disclosure is capable of various modifications and alternative forms, specific embodiments thereof are shown by way of example in the drawings and will herein be described in detail. It should be understood, however, that there is no intent to limit the present disclosure to the particular forms disclosed, but on the contrary, the present disclosure is to cover all modifications, equivalents, and alternatives falling within the spirit and scope of the present disclosure. Like numbers refer to like elements throughout the description of the figures.

It will be understood that, although the terms first, second, etc. may be used herein to describe various elements, these elements should not be limited by these terms. These terms are only used to distinguish one element from another. For example, a first element could be termed a second element, and, similarly, a second element could be termed a first element, without departing from the scope of the present disclosure. As used herein, the term “and/or” includes any and all combinations of one or more of the associated listed items.

In exemplary embodiments of the present disclosure, “at least one of A and B” may refer to “at least one A or B” or “at least one of one or more combinations of A and B”. In addition, “one or more of A and B” may refer to “one or more of A or B” or “one or more of one or more combinations of A and B”.

It will be understood that when an element is referred to as being “connected” or “coupled” to another element, it can be directly connected or coupled to the other element or intervening elements may be present. In contrast, when an element is referred to as being “directly connected” or “directly coupled” to another element, there are no intervening elements present. Other words used to describe the relationship between elements should be interpreted in a like fashion (i.e., “between” versus “directly between,” “adjacent” versus “directly adjacent,” etc.).

The terminology used herein is for the purpose of describing particular embodiments only and is not intended to be limiting of the present disclosure. As used herein, the singular forms “a,” “an” and “the” are intended to include the plural forms as well, unless the context clearly indicates otherwise. It will be further understood that the terms “comprises,” “comprising,” “includes” and/or “including,” when used herein, specify the presence of stated features, integers, steps, operations, elements, and/or components, but do not preclude the presence or addition of one or more other features, integers, steps, operations, elements, components, and/or groups thereof.

Unless otherwise defined, all terms (including technical and scientific terms) used herein have the same meaning as commonly understood by one of ordinary skill in the art to which this present disclosure belongs. It will be further understood that terms, such as those defined in commonly used dictionaries, should be interpreted as having a meaning that is consistent with their meaning in the context of the relevant art and will not be interpreted in an idealized or overly formal sense unless expressly so defined herein.

A communication system to which exemplary embodiments according to the present disclosure are applied will be described. The communication system to which the exemplary embodiments according to the present disclosure are applied is not limited to the contents described below, and the exemplary embodiments according to the present disclosure may be applied to various communication systems. Here, the communication system may have the same meaning as a communication network.

Throughout the present disclosure, a network may include, for example, a wireless Internet such as wireless fidelity (WiFi), mobile Internet such as a wireless broadband Internet (WiBro) or a world interoperability for microwave access (WiMax), 2G mobile communication network such as a global system for mobile communication (GSM) or a code division multiple access (CDMA), 3G mobile communication network such as a wideband code division multiple access (WCDMA) or a CDMA2000, 3.5G mobile communication network such as a high speed downlink packet access (HSDPA) or a high speed uplink packet access (HSUPA), 4G mobile communication network such as a long term evolution (LTE) network or an LTE-Advanced network, 5G mobile communication network, beyond 5G (B5G) mobile communication network (e.g. 6G mobile communication network), or the like.

Throughout the present disclosure, a terminal may refer to a mobile station, mobile terminal, subscriber station, portable subscriber station, user equipment, access terminal, or the like, and may include all or a part of functions of the terminal, mobile station, mobile terminal, subscriber station, mobile subscriber station, user equipment, access terminal, or the like.

Here, a desktop computer, laptop computer, tablet PC, wireless phone, mobile phone, smart phone, smart watch, smart glass, e-book reader, portable multimedia player (PMP), portable game console, navigation device, digital camera, digital multimedia broadcasting (DMB) player, digital audio recorder, digital audio player, digital picture recorder, digital picture player, digital video recorder, digital video player, or the like having communication capability may be used as the terminal.

Throughout the present specification, the base station may refer to an access point, radio access station, node B (NB), evolved node B (eNB), base transceiver station, mobile multihop relay (MMR)-BS, or the like, and may include all or part of functions of the base station, access point, radio access station, NB, eNB, base transceiver station, MMR-BS, or the like.

Hereinafter, preferred exemplary embodiments of the present disclosure will be described in more detail with reference to the accompanying drawings. In describing the present disclosure, in order to facilitate an overall understanding, the same reference numerals are used for the same elements in the drawings, and duplicate descriptions for the same elements are omitted.

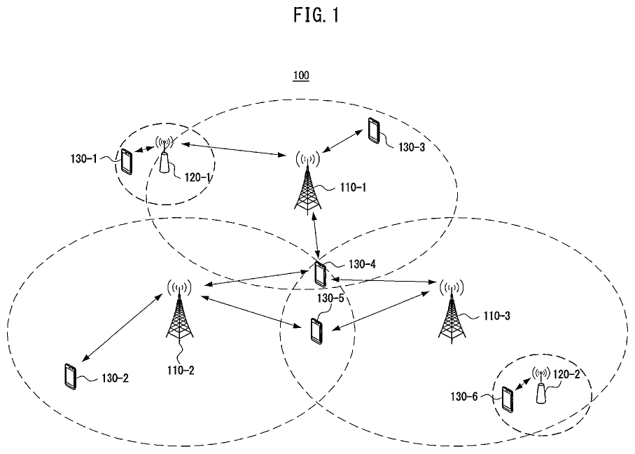

FIG. 1 is a conceptual diagram illustrating an exemplary embodiment of a communication system.

Referring to FIG. 1, a communication system 100 may comprise a plurality of communication nodes 110-1, 110-2, 110-3, 120-1, 120-2, 130-1, 130-2, 130-3, 130-4, 130-5, and 130-6. The plurality of communication nodes may support 4G communication (e.g. long term evolution (LTE), LTE-advanced (LTE-A)), 5G communication (e.g. new radio (NR)), 6G communication, etc. specified in the 3rd generation partnership project (3GPP) standards. The 4G communication may be performed in frequency bands below 6 GHz, and the 5G communication may be performed in frequency bands above 6 GHz as well as frequency bands below 6 GHz.

For example, in order to perform the 4G communication, 5G communication, and 6G communication, the plurality of communication may support a code division multiple access (CDMA) based communication protocol, wideband CDMA (WCDMA) based communication protocol, time division multiple access (TDMA) based communication protocol, frequency division multiple access (FDMA) based communication protocol, orthogonal frequency division multiplexing (OFDM) based communication protocol, filtered OFDM based communication protocol, cyclic prefix OFDM (CP-OFDM) based communication protocol, discrete Fourier transform spread OFDM (DFT-s-OFDM) based communication protocol, orthogonal frequency division multiple access (OFDMA) based communication protocol, single carrier FDMA (SC-FDMA) based communication protocol, non-orthogonal multiple access (NOMA) based communication protocol, generalized frequency division multiplexing (GFDM) based communication protocol, filter bank multi-carrier (FBMC) based communication protocol, universal filtered multi-carrier (UFMC) based communication protocol, space division multiple access (SDMA) based communication protocol, orthogonal time-frequency space (OTFS) based communication protocol, or the like.

Further, the communication system 100 may further include a core network. When the communication 100 supports 4G communication, the core network may include a serving gateway (S-GW), packet data network (PDN) gateway (P-GW), mobility management entity (MME), and the like. When the communication system 100 supports 5G communication or 6G communication, the core network may include a user plane function (UPF), session management function (SMF), access and mobility management function (AMF), and the like.

Meanwhile, each of the plurality of communication nodes 110-1, 110-2, 110-3, 120-1, 120-2, 130-1, 130-2, 130-3, 130-4, 130-5, and 130-6 constituting the communication system 100 may have the following structure.

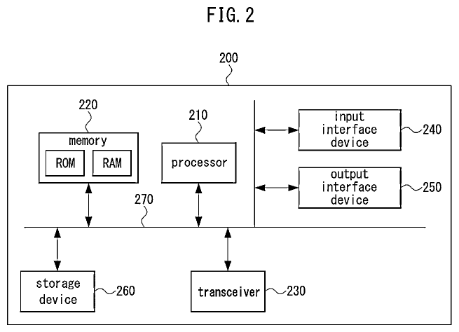

FIG. 2 is a block diagram illustrating an exemplary embodiment of a communication node constituting a communication system.

Referring to FIG. 2, a communication node 200 may comprise at least one processor 210, a memory 220, and a transceiver 230 connected to the network for performing communications. Also, the communication node 200 may further comprise an input interface device 240, an output interface device 250, a storage device 260, and the like. Each component included in the communication node 200 may communicate with each other as connected through a bus 270.

However, each component included in the communication node 200 may not be connected to the common bus 270 but may be connected to the processor 210 via an individual interface or a separate bus. For example, the processor 210 may be connected to at least one of the memory 220, the transceiver 230, the input interface device 240, the output interface device 250 and the storage device 260 via a dedicated interface.

The processor 210 may execute a program stored in at least one of the memory 220 and the storage device 260. The processor 210 may refer to a central processing unit (CPU), a graphics processing unit (GPU), or a dedicated processor on which methods in accordance with embodiments of the present disclosure are performed. Each of the memory 220 and the storage device 260 may be constituted by at least one of a volatile storage medium and a non-volatile storage medium. For example, the memory 220 may comprise at least one of read-only memory (ROM) and random access memory (RAM).

Referring again to FIG. 1, the communication system 100 may comprise a plurality of base stations 110-1, 110-2, 110-3, 120-1, and 120-2, and a plurality of terminals 130-1, 130-2, 130-3, 130-4, 130-5, and 130-6. Each of the first base station 110-1, the second base station 110-2, and the third base station 110-3 may form a macro cell, and each of the fourth base station 120-1 and the fifth base station 120-2 may form a small cell. The fourth base station 120-1, the third terminal 130-3, and the fourth terminal 130-4 may belong to cell coverage of the first base station 110-1. Also, the second terminal 130-2, the fourth terminal 130-4, and the fifth terminal 130-5 may belong to cell coverage of the second base station 110-2. Also, the fifth base station 120-2, the fourth terminal 130-4, the fifth terminal 130-5, and the sixth terminal 130-6 may belong to cell coverage of the third base station 110-3. Also, the first terminal 130-1 may belong to cell coverage of the fourth base station 120-1, and the sixth terminal 130-6 may belong to cell coverage of the fifth base station 120-2.

Here, each of the plurality of base stations 110-1, 110-2, 110-3, 120-1, and 120-2 may refer to a Node-B (NB), evolved Node-B (eNB), gNB, base transceiver station (BTS), radio base station, radio transceiver, access point, access node, road side unit (RSU), radio remote head (RRH), transmission point (TP), transmission and reception point (TRP), or the like.

Each of the plurality of terminals 130-1, 130-2, 130-3, 130-4, 130-5, and 130-6 may refer to a user equipment (UE), terminal, access terminal, mobile terminal, station, subscriber station, mobile station, portable subscriber station, node, device, Internet of Thing (IoT) device, mounted module/device/terminal, on-board device/terminal, or the like.

Meanwhile, each of the plurality of base stations 110-1, 110-2, 110-3, 120-1, and 120-2 may operate in the same frequency band or in different frequency bands. The plurality of base stations 110-1, 110-2, 110-3, 120-1, and 120-2 may be connected to each other via an ideal backhaul or a non-ideal backhaul, and exchange information with each other via the ideal or non-ideal backhaul. Also, each of the plurality of base stations 110-1, 110-2, 110-3, 120-1, and 120-2 may be connected to the core network through the ideal or non-ideal backhaul. Each of the plurality of base stations 110-1, 110-2, 110-3, 120-1, and 120-2 may transmit a signal received from the core network to the corresponding terminal 130-1, 130-2, 130-3, 130-4, 130-5, or 130-6, and transmit a signal received from the corresponding terminal 130-1, 130-2, 130-3, 130-4, 130-5, or 130-6 to the core network.

In addition, each of the plurality of base stations 110-1, 110-2, 110-3, 120-1, and 120-2 may support multi-input multi-output (MIMO) transmission (e.g. a single-user MIMO (SU-MIMO), multi-user MIMO (MU-MIMO), massive MIMO, or the like), coordinated multipoint (CoMP) transmission, carrier aggregation (CA) transmission, transmission in an unlicensed band, device-to-device (D2D) communications (or, proximity services (ProSe)), or the like. Here, each of the plurality of terminals 130-1, 130-2, 130-3, 130-4, 130-5, and 130-6 may perform operations corresponding to the operations of the plurality of base stations 110-1, 110-2, 110-3, 120-1, and 120-2, and operations supported by the plurality of base stations 110-1, 110-2, 110-3, 120-1, and 120-2. For example, the second base station 110-2 may transmit a signal to the fourth terminal 130-4 in the SU-MIMO manner, and the fourth terminal 130-4 may receive the signal from the second base station 110-2 in the SU-MIMO manner. Alternatively, the second base station 110-2 may transmit a signal to the fourth terminal 130-4 and fifth terminal 130-5 in the MU-MIMO manner, and the fourth terminal 130-4 and fifth terminal 130-5 may receive the signal from the second base station 110-2 in the MU-MIMO manner.

The first base station 110-1, the second base station 110-2, and the third base station 110-3 may transmit a signal to the fourth terminal 130-4 in the CoMP transmission manner, and the fourth terminal 130-4 may receive the signal from the first base station 110-1, the second base station 110-2, and the third base station 110-3 in the CoMP manner. Also, each of the plurality of base stations 110-1, 110-2, 110-3, 120-1, and 120-2 may exchange signals with the corresponding terminals 130-1, 130-2, 130-3, 130-4, 130-5, or 130-6 which belongs to its cell coverage in the CA manner. Each of the base stations 110-1, 110-2, and 110-3 may control D2D communications between the fourth terminal 130-4 and the fifth terminal 130-5, and thus the fourth terminal 130-4 and the fifth terminal 130-5 may perform the D2D communications under control of the second base station 110-2 and the third base station 110-3.

Hereinafter, methods for configuring and managing radio interfaces in a communication system will be described. Even when a method (e.g. transmission or reception of a signal) performed at a first communication node among communication nodes is described, the corresponding second communication node may perform a method (e.g. reception or transmission of the signal) corresponding to the method performed at the first communication node. That is, when an operation of a terminal is described, a corresponding base station may perform an operation corresponding to the operation of the terminal. Conversely, when an operation of a base station is described, a corresponding terminal may perform an operation corresponding to the operation of the base station.

Meanwhile, in a communication system, a base station may perform all functions (e.g. remote radio transmission/reception function, baseband processing function, and the like) of a communication protocol. Alternatively, the remote radio transmission/reception function among all the functions of the communication protocol may be performed by a transmission and reception point (TRP) (e.g. flexible (f)-TRP), and the baseband processing function among all the functions of the communication protocol may be performed by a baseband unit (BBU) block. The TRP may be a remote radio head (RRH), radio unit (RU), transmission point (TP), or the like. The BBU block may include at least one BBU or at least one digital unit (DU). The BBU block may be referred to as a ‘BBU pool’, ‘centralized BBU’, or the like. The TRP may be connected to the BBU block through a wired fronthaul link or a wireless fronthaul link. The communication system composed of backhaul links and fronthaul links may be as follows. When a functional split scheme of the communication protocol is applied, the TRP may selectively perform some functions of the BBU or some functions of medium access control (MAC)/radio link control (RLC) layers.

The International Telecommunication Union (ITU) is developing the International Mobile Telecommunication (IMT) framework and standards. Recently, discussions for 6th generation (6G) communications have been underway through the ‘IMT for 2030 and beyond’ program. Among the technologies that are receiving significant attention for the implementation of 6G are artificial intelligence (AI) and machine learning (ML). The 3rd Generation Partnership Project (3GPP) began researches on AI/ML technologies for the air interface in Release 18. The main use cases for the researches conducted by 3GPP are as follows.
AI/ML for improving channel state information (CSI) feedback;
AI/ML for beam management; and
AI/ML for positioning performance enhancement.

The present disclosure is highly related to the first use case, which aims to improve the performance of CSI feedback.

Specifically, in a communication system, a transmitter performs operations such as coding level adjustment, power allocation, and beamforming using multiple transmission antennas to transmit data to a receiver. To this end, the transmitter needs to obtain information on a wireless channel between antennas of the transmitter and the receiver. However, since the channel from the transmitter to the receiver cannot be directly observed at the transmission side, a procedure is required in which the receiver reports channel information measured at the receiver to the transmitter, refer to as a Channel State Information (CSI) reporting procedure. The CSI is information used by the transmitter to schedule data transmission to the receiver and may include rank, channel quality index (CQI), and precoding information.

To measure the channel state at the receiver, reference signals such as Channel State Information-Reference Signal (CSI-RS) has been designed. The transmitter periodically or aperiodically transmits CSI-RS, and transmission-related information is pre-configured so that the receiver receives the CSI-RS. After the receiver receives the CSI-RS, it generates CSI and carries out a CSI reporting procedure to deliver the CSI to the transmitter. To represent the channel information accurately, a large amount of information is required, which increases consumption of radio transmission resources and overhead, consequently reducing system performance. Precisely representing the channel information that reflects channel variations for the transmitter to determine precoding or precoding information recommended by the receiver for appropriate precoding vectors may result in significant overhead.

In communication systems, to address these issues, researches have begun on using AI/ML technologies to minimize the amount of transmitted information while allowing the transmitter to acquire channel state information with high accuracy. Discussions are also underway on applying AI/ML technologies to communication systems beyond the 5th generation. An AI/ML architecture for delivering channel information has been proposed, based on an autoencoder neural network. The proposed approach involves inputting wireless channel information in form of images and compressing it into a code vector in a low-dimensional latent space through an encoder network, using a convolutional neural network (CNN)-based artificial neural network to restore the original wireless state. The CNN-based neural network has demonstrated effective compression and restoration capabilities. Since transmitting the entire channel information involves a large amount of data and the compressed low-dimensional code vector contains real numbers, an additional quantization process needs to be considered for transmission of the information from the receiver to the transmitter.

In case of a double-sided AI/ML model for CSI feedback, inference may be performed jointly by models that exist on both a terminal side and a base station side. There may be constraints that require the AI/ML models used for inference to operate in conjunction.

To satisfy the aforementioned constraints, a pair of AI/ML models may be trained through joint training or sequential training. In joint training, the pair of AI/ML models may be trained at a first node (e.g. base station) and then distributed. In sequential training, a result learned at the first node may be delivered to a second node (e.g. terminal) for further training.

As described above, in sequential training, the first node may transfer training data to the second node. The second node may perform training using the data received from the first node. However, in sequential training, there may be an issue where the size of the training data becomes very large. Information on an artificial neural network (ANN) configured at the first node may not exist at the second node, and there may be difficulties in efficiently configuring the ANN.

The present disclosure proposes efficient methods for sequential training on AI/ML models used to perform CSI feedback, as follows.

### Efficient Method for Configuring Training Data for Sequential Training

### Method 1

In the present disclosure, a communication system may include a base station and at least one terminal. The base station (or terminal) (hereinafter, ‘first training node’) may use raw training data to train a part of a double-sided AI/ML model. The first training node may configure sequential training data for training on the terminal (or base station) (hereinafter, ‘second training node’). The present disclosure proposes that the first training node transfers the sequential training data to the second training node, enabling the second training node to perform training using the sequential training data.

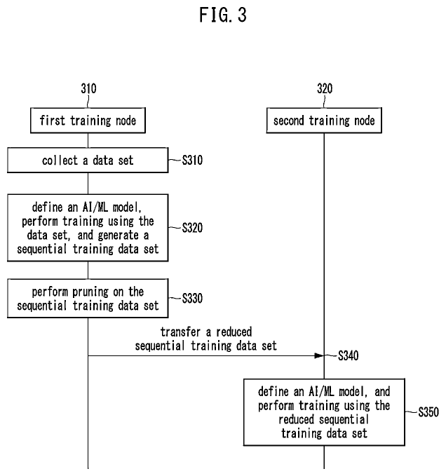

FIG. 3 is a sequence chart illustrating a sequential training method of a double-sided AI/ML model for channel state information feedback according to exemplary embodiments of the present disclosure.

Referring to FIG. 3, a communication system may include a first training node 310 and a second training node 320. The first training node may be the base station 110-1, 110-2, 110-3, 120-1, or 120-2 illustrated in FIG. 1, and the second training node may be the terminal 130-1, 130-2, 130-3, 130-4, 130-5, or 130-6 illustrated in FIG. 1. The first training node and the second training node may be configured identically or similarly to the communication node illustrated in FIG. 2. The first training node 310 may train a part of an AI/ML model by using raw training data. The second training node 320 may train the AI/ML model using the trained part transferred from the first training node 310. The AI/ML model may refer to a double-sided AI/ML model for CSI feedback. The double-sided AI/ML model may include an encoder model and/or a decoder model. In FIG. 3, one second training node 320 is illustrated for convenience of description, but a plurality of second training nodes may exist in the communication system.

In step S310, the first training node 310 may collect a data set for AI/ML model training. The collected data set may include multiple raw training data. The collected data set may be referred to as a raw training data set. An AI/ML model may refer to a double-sided AI/ML model for CSI feedback. The double-sided AI/ML model may include an encoder model and/or a decoder model.

In step S320, the first training node 310 may define an AI/ML model. Using the data set collected in step S310, the first training node 310 may perform training on the AI/ML model. The first training node 310 may generate a data set for sequential training on the AI/ML model. The data set for sequential training may be referred to as a sequential training data set, and data for sequential training may be referred to as sequential training data. The sequential training data set may include multiple sequential training data.

The raw training data may include sample(s) of channel information. The channel information may be a channel matrix or a precoding vector. When the channel information is expressed as a precoding vector, the channel information may be expressed as raw information itself or in form of a codebook defined in the technical specifications (e.g. enhanced Type II of 3GPP). When the channel information is expressed in form of a codebook defined in the technical specifications, a codebook parameter may be expressed using the largest parameter defined in the technical specifications (e.g. paramCombination 6 or 8) or a larger parameter.

When the channel information is expressed as raw information itself, the channel information may be unquantized or quantized. Whether the channel information is quantized and/or a quantization scheme thereof may be delivered as being included in sequential training data information. Mapping information may be unquantized or quantized. Whether the mapping information is quantized and/or a quantization scheme thereof may be delivered as being included in the sequential training data information. The sequential training data may refer to training data for sequential training.

The sequential training data may include a pair of channel information (e.g. channel matrix or eigenvector, etc.) and mapping information for the channel information, and the mapping information may be determined according to a training result of the first training node (e.g. base station). In addition to the channel information, the raw training data may include site/cell information, region information, etc., and may also include a signal-to-noise ratio (SNR) for each sample. The sequential training data may further include a performance value (e.g. restoration performance information) of the first training node for each sample or all samples.

The sequential training data may include a smaller number of samples than the samples included in the channel information of the raw training data.

In step S330, the first training node 310 may perform pruning on the sequential training data set generated in step 320 to obtain (or determine) a reduced sequential training data set. The first training node 310 may perform pruning on the sequential training data set according to a predetermined scheme.

The reduced sequential training data set may include multiple sequential training data. As described above, the sequential training data may include a pair of channel information and mapping information for the channel information. The mapping information may be determined based on a training result of the first training node (e.g. base station).

The second training node 320 may use the reduced sequential training data set obtained (or determined) in step 330 to train an AI/ML model. The first training node 310 may perform step S340 to transfer (or transmit) the reduced sequential training data set obtained (or determined) in step 330 to the second training node 320. As described above, the AI/ML model may refer to a double-sided AI/ML model for CSI feedback.

In step S340, the first training node 310 may transfer (or transmit) the reduced sequential training data set to the second training node 320. The second training node 320 may receive the reduced sequential training data set from the first training node 310.

The first training node 310 may transfer (or transmit) double-sided AI/ML training data information including the reduced sequential training data set and/or sequential training data configuration information to the second training node 320. The second training node 320 may receive the double-sided AI/ML training data information including the reduced sequential training data set and/or sequential training data configuration information from the first training node 310. The sequential training data configuration information will be described later.

In an exemplary embodiment, the reduced sequential training data set may be included in the double-sided AI/ML training data information. The first training node 310 may transfer (or transmit) the double-sided AI/ML training data information including the reduced sequential training data set to the second training node 320. The second training node 320 may receive the double-sided AI/ML training data information including the reduced sequential training data set.

In step S350, the second training node 320 may define an AI/ML model. The second training node 320 may perform training on the AI/ML model using the reduced sequential training data set received in step S340. As described above, the AI/ML model may refer to a double-sided AI/ML model for CSI feedback.

The sequential training method of the double-sided AI/ML model for CSI feedback described above may further include a step (hereinafter, ‘CSI feedback transmission step’) in which the second training node 320 transmits CSI feedback information after step S350 is performed.

In the CSI feedback transmission step, the second training node 320 may transmit CSI feedback information to the first training node 310 based on the AI/ML model trained in step S350. The first training node 310 may receive the CSI feedback information based on the AI/ML model from the second training node 320.

For convenience of description, the first training node 310 collects the data set for sequential training of the double-sided AI/ML model for CSI feedback in step S310, but is not limited thereto. The first training node 310 defines the double-sided AI/ML model for CSI feedback in step S320, but is not limited thereto. The second training node 320 defines the double-sided AI/ML model for CSI feedback in step S350, but is not limited thereto.

In an exemplary embodiment, in the sequential training method of the double-sided AI/ML model for CSI feedback illustrated in FIG. 3, it may be assumed that collection of the data set in the first training node 310 has been completed. It may be assumed that the AI/ML model in the first training node 310 and the AI/ML model in the second training node 320 are predefined. As described above, the AI/ML model may refer to a double-sided AI/ML model for CSI feedback.

In the above-described sequential training method of the double-sided AI/ML model for CSI feedback, steps S310 to S350 have been described individually, but this is not intended to limit an order in which the steps are performed, and when necessary, the respective steps may be performed simultaneously or in a different order, or at least some of them may be combined.

In an exemplary embodiment of the present disclosure, the base station and the terminal may sequentially train the double-sided AI/ML model for CSI feedback. The first training node may be assumed to be the base station, and the second training node may be assumed to be the terminal. The double-sided AI/ML model may include an encoder model and/or a decoder model.

When the base station is the first training node, the double-sided AI/ML model in the base station may include an encoder model and a decoder model. The base station may define the encoder model and the decoder model. The base station may train the double-sided AI/ML model using raw training data. The encoder model may be a nominal model and may not be used in actual inference (e.g. CSI feedback operation).

After the double-sided AI/ML model in the base station is trained using the raw training data, the base station may perform a process of reducing the raw training data to configure sequential training data. In this case, quantization may be applied to channel information of each sample of the raw training data, and the number of samples may be reduced. Through this process, the sequential training data may be reduced in size compared to the raw training data.

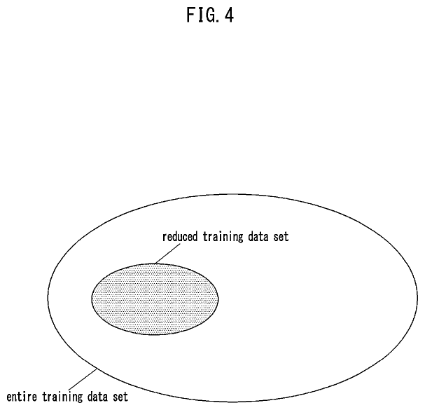

FIG. 4 is a conceptual diagram illustrating training data for sequential training of a double-sided AI/ML model according to exemplary embodiments of the present disclosure.

Referring to FIG. 4, a training data set for sequential training may include a reduced training data set. The reduced training data set may be a part of the entire training data set. The entire training data set illustrated in FIG. 4 may refer to the training data set for sequential training.

When the terminal is the second training node, the base station may transfer (or transmit) the reduced training data set to the terminal so that the terminal performs sequential training on an encoder model included in a double-sided AI/ML. Similarly to the base station, the double-sided AI/ML model in the terminal may include the encoder model and a decoder model, and the terminal may define the encoder model and the decoder model. The terminal may perform training on the double-sided AI/ML model using the sequential training data received from the base station. When the terminal trains the double-sided AI/ML model, the decoder model included in the double-sided AI/ML model may not be used in an actual inference process.

### Method 1-1

The first training node may transfer (transmit) sequential training data configuration information to the second training node. The sequential training data configuration information may include at least one of the following:
The number of samples of the raw training data;
Additional information of the raw training data;
For example, the additional information of the raw training data may include site/cell information, region information, SNR, etc.
The number of samples of the sequential training data;
Reduction ratio of the number of the sequential training data;
Type of channel information;
Whether channel information is quantized and quantization scheme thereof;
Quantization scheme of mapping information; or
Performance value according to the model and training of the first training node.

As described above, in the sequential training method of the double-sided AI/ML model for CSI feedback, the first training node (e.g. base station) may transmit (or transfer) the double-sided AI/ML training data information to the second training node (e.g. terminal). The sequential training data configuration information may be included in the double-sided AI/ML training data information.

In an exemplary embodiment, the first training node may sequentially transmit first double-sided AI/ML training data information and second double-sided AI/ML training data information to the second training node. The first double-sided AI/ML training data information may include the reduced sequential training data set, and the second double-sided AI/ML training data information may include the sequential training data configuration information.

In another exemplary embodiment, the first training node may transmit double-sided AI/ML training data information including the reduced sequential training data set and the sequential training data configuration information to the second training node.

### Method 1-2

The first training node may reduce the sequential training data by at least one of the following schemes. As described above, the sequential training data may refer to training data for sequential training for the two-sided AI/ML model.
Random sampling-based reduction;
Density-based reduction of channel information;
Density-based reduction of mapping information; or
Model-based importance-driven reduction.

The first training node may further include information on a scheme for reducing the sequential training data in the sequential training data configuration information and transfer (or transmit) it to the second training node.

In an exemplary embodiment, the first training node may be assumed to be the base station and the second training node may be assumed to be the terminal. When the base station performs a reduction process to reduce the number of samples in the raw training data, the base station may apply one of several schemes.

First, random sampling-based reduction may be performed, which may mean configuring the sequential training data with randomly selected samples from the entire samples.

Second, density-based reduction of channel information may be performed, which may be a scheme of reducing the number of samples having similar channel information. In this scheme, whether to select each sample may be determined based on a distance between channel information of each sample and channel information of other samples.

Third, density-based reduction of mapping information may be applied, which may be a scheme of reducing the number of samples having similar mapping information. In this scheme, whether to select each sample may be determined based on a distance between mapping information of each sample and mapping information of other samples.

Fourth, a two-sided AI/ML model-based importance-driven reduction may be applied, which may be a scheme of selecting a sample based on a degree to which the sample is important for training the model. In this scheme, importance of each sample may be selected using a trained two-sided AI/ML model (encoder model and/or decoder model). The importance of a sample may be measured based on the model using a size and/or variation of a loss function for each channel information input.

In addition to the above-described schemes, the number of samples may be reduced by other scheme(s), and in this case, information on the reduction scheme may be delivered to the second training node.

### Method 1-3

The first training node may transfer (or transmit) sequential training data configuration information including importance and/or density information for each sample of the sequential training data to the second training node. The importance and/or density information for each sample may be determined according to the scheme of reducing the sequential training data. As described above, the sequential training data may refer to training data for sequential training of the two-sided AI/ML model.

For example, if the scheme of reducing the sequential training data is the importance-based scheme, the first training node may transfer (or transmit) the sequential training data configuration information including importance information for each sample of the sequential training data to the second training node. If the scheme of reducing the sequential training data is the density-based scheme, the first training node may transfer (or transmit) the sequential training data configuration information including density information for each sample of the sequential training data to the second training node.

### Method 1-4

The second training node may receive the sequential training data from the first training node. The second training node may train an artificial neural network related to the two-sided AI/ML model by applying a data augmentation scheme to the sequential training data received from the first training node. When the second training node performs the data augmentation scheme, the second training node may use the importance and/or density information for each sample of the sequential training data. As described above in Method 1-3, the sequential training data configuration information may include the importance and/or density information for each sample of the sequential training data.

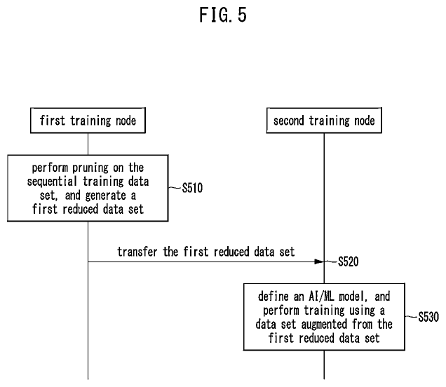

FIG. 5 is a sequence chart illustrating a sequential training method of a two-sided AI/ML model using data augmentation according to exemplary embodiments of the present disclosure.

Referring to FIG. 5, the first training node may perform pruning on the data set for sequential training to generate a reduced data set. The second training node may receive the reduced data set from the first training node. The second training node may perform training on the two-sided AI/ML model by applying data augmentation on the reduced data set. The application of data augmentation may be determined by the second training node or may be instructed by the first training node. When the second training node determines the application of data augmentation, the second training node may transmit information indicating that the second training node has determined the application of data augmentation to the first training node. The first training node may be the first training node 310 illustrated in FIG. 3, and the second training node may be the second training node 320 illustrated in FIG. 3. For convenience of description, in the sequential training method using data augmentation illustrated in FIG. 5, the step of transmitting information indicating that the second training node has determined the application of data augmentation is omitted, but the sequential training method using data augmentation may include the step of transmitting information indicating that the second training node has determined the application of data augmentation.

In step S510, the first training node may perform pruning on the data set for sequential training to generate (or obtain) a first reduced data set. The data set for sequential training may be referred to as the sequential training data set. The reduced data set may be referred to as a reduced sequential training data set.

In step S520, the first training node may transmit the first reduced data set generated (or obtained) in step 510 to the second training node. The second training node may receive the first reduced data set from the first training node.

In step S530, the second terminal node may define an AI/ML model. The second training node may perform training on the AI/ML model using the first reduced data set received in step S520. As described above, the AI/ML model may refer to a double-sided AI/ML model for CSI feedback.

The training on the two-sided AI/ML model may be performed by applying data augmentation to the reduced data set. When the data augmentation scheme is applied, training may be performed on an artificial neural network related to the two-sided AI/ML model. The data augmentation scheme may apply at least one of the following. As described above, the two-sided AI/ML model may refer to the two-sided AI/ML model for CSI feedback. The two-sided AI/ML model may include an encoder model and/or a decoder model.
A noise-addition scheme;
A rotation scheme; or
A scheme using a generative AI model (generative AI model-based scheme).

According to exemplary embodiments of the present disclosure, when reduction in the number of samples is applied to the raw training data, the second training node may perform training on the two-sided AI/ML model by applying data augmentation to the sequential training data.

In an exemplary embodiment, data augmentation based on the noise-addition scheme may be applied. When data augmentation based on the noise-addition scheme is applied, one or more samples obtained by adding random noise to channel information of one raw sample may be additionally generated. The added mapping information may use the same mapping information as the raw sample.

In another exemplary embodiment, the rotation scheme may be applied as the data augmentation scheme. One or more samples may be additionally generated by applying an arbitrary rotation transformation to channel information of one raw sample. The added mapping information may use the mapping information of the raw sample in the same manner.

In yet another exemplary embodiment, the scheme using a generative AI model may be applied as the data augmentation scheme. At least one sample may be generated using the generative AI model. Each of the at least one sample may be composed of a pair of channel information and mapping information.

As described above, the application of data augmentation may be determined by the second training node or may be instructed by the first training node. When the second training node determines the application of data augmentation, the second training node may transmit information indicating that the second training node has determined the application of data augmentation to the first training node. For convenience of description, in the sequential training method using data augmentation illustrated in FIG. 5, the step of transmitting information indicating that the second training node has determined the application of data augmentation (hereinafter, the step of indicating the application of data augmentation) is omitted, but the sequential training method using data augmentation may include the step of indicating the application of data augmentation.

In the step of indicating the application of data augmentation, the second training node may transmit information indicating that the second training node has determined the application of data augmentation to the first training node. The first training node may receive the information indicating that the second training node has determined the application of data augmentation from the second training node. The first training node may confirm that data augmentation has been applied to training on the two-sided AI/ML model in the second training node.

In an exemplary embodiment, the information indicating that the second training node has determined the application of data augmentation may include information related to the scheme applied for data augmentation. As described above, the scheme applied for data augmentation may be at least one of the noise-addition scheme, rotation scheme, or generative AI model-based scheme.

In addition to the above-described data augmentation schemes, other data augmentation scheme(s) may be applied to perform data augmentation.

In the sequential training method of the two-sided AI/ML model using data augmentation, steps S510 to S530 have been described individually, but this is not intended to limit an order in which the steps are performed, and when necessary, the respective steps may be performed simultaneously or in a different order, or at least some of the steps may be combined.

### Method 1-5

The first training node may newly or additionally train an artificial neural network using the sequential training data. The first training node may use the trained artificial neural network in the inference (e.g., CSI feedback) process. The data augmentation scheme applied in the second training node may be considered in the first training node. When the second training node performs data augmentation, the first training node may perform artificial neural network training by applying the same data augmentation scheme as the second training node.

As described above, in the step of indicating the application of data augmentation, the first training node may receive the information indicating that the second training node has determined the application of data augmentation from the second training node. The first training node may confirm that data augmentation has been applied to training on the AI/ML model in the second training node. The first training node may confirm the data augmentation scheme applied to training on the double-sided AI/ML model in the second training node. The first training node may perform artificial neural network training using the same scheme as the data augmentation scheme applied to training on the AI/ML model in the second training node.

### Method 1-6

The first training node may transfer (or transmit) the first reduced sequential training data to the second training node. Thereafter, the first training node may configure (or generate) a second reduced sequential training data for additional training. The first training node may transfer (or transmit) the second reduced training data to the second training node. The second training node may receive the second reduced sequential training data from the first training node. The second training node may perform additional training on the double-sided AI/ML model using the second reduced sequential training data. As described above, the double-sided AI/ML model may refer to a double-sided AI/ML model for CSI feedback. The double-sided AI/ML model may include an encoder model and/or a decoder model.

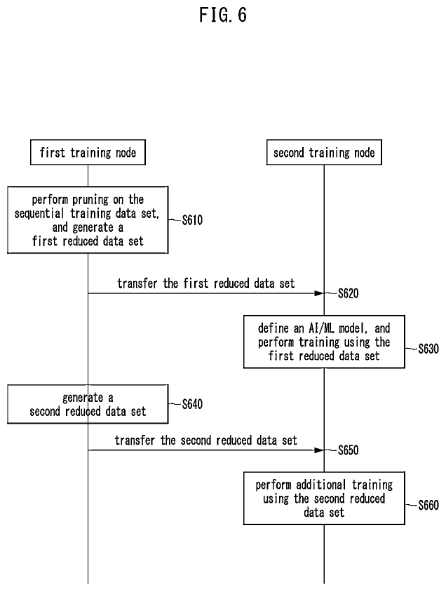

FIG. 6 is a sequence chart illustrating an additional training method in a sequential training method of a double-sided AI/ML model according to exemplary embodiments of the present disclosure.

Referring to FIG. 6, the communication system may include the first training node and the second training node. The first training node may generate a reduced data set for additional training and transfer (or transmit) the reduced data set to the second training node. The second training node may receive the reduced data set for additional training from the first training node and perform training on the double-sided AI/ML model. It may be assumed that a sequential training data set for the double-sided AI/ML model has been generated in the first training node. The first training node may be the first training node 310 illustrated in FIG. 3, and the second training node may be the second training node 320 illustrated in FIG. 3. The double-sided AI/ML model may refer to a double-sided AI/ML model for CSI feedback. The double-sided AI/ML model may include an encoder model and/or a decoder model.

In step S610, the first training node may perform pruning on the sequential training data set to generate (or obtain) a first reduced sequential training data set. As described above, the first training node may perform pruning according to a predetermined scheme.

In step S620, the first training node may transmit the first reduced sequential training data set generated (or obtained) in step S610 to the second training node. The second training node may receive the first reduced sequential training data set from the first training node.

As described above, the first training node may transfer (or transmit) first double-sided AI/ML training data information including the first reduced sequential training data set and/or first sequential training data configuration information to the second training node. The second training node may receive the first double-sided AI/ML training data information including the first reduced sequential training data set and/or the first sequential training data configuration information from the first training node.

In an exemplary embodiment, the first reduced sequential training data set may be included in the first double-sided AI/ML training data information. The first training node may transfer (or transmit) the first double-sided AI/ML training data information including the first reduced sequential training data set to the second training node. The second training node may receive the first double-sided AI/ML training data information including the first reduced sequential training data set.

In step S630, the second training node may define an AI/ML model. The second training node may perform training on the AI/ML model using the reduced sequential training data set received in step S620. As described above, the AI/ML model may refer to a double-sided AI/ML model for CSI feedback. The double-sided AI/ML model may include an encoder model and/or a decoder model.

The first training node may determine whether to perform additional training on the AI/ML model according to a predetermined scheme. If the first training node determines that additional training on the AI/ML model is required, the first training node may perform step S640.

In step S640, the first training node may generate (or obtain) a second reduced data set for additional training. The second reduced data set may be used to perform additional training on the AI/ML model. The first training node may generate (or obtain) the second reduced data set according to a predetermined scheme.

In step S650, the first training node may transfer (or transmit) the second reduced data set generated (or obtained) in step S640 to the second training node. The second training node may receive the second reduced data set from the first training node. In step S660, the second training node may perform additional training on the AI/ML model using the second reduced data set received in step S650.

The first training node may transfer (or transmit) second double-sided AI/ML training data information including the second reduced sequential training data set and/or second sequential training data configuration information to the second training node. The second training node may receive the second double-sided AI/ML training data information including the second reduced sequential training data set and/or the second sequential training data configuration information from the first training node. The second sequential training data configuration information may include information indicating that the second reduced sequential training data set is used for additional training.

In an exemplary embodiment, the second double-sided AI/ML training data information may include the second reduced sequential training data set and the second sequential training data configuration information. The second sequential training data configuration information may include information indicating that the second reduced sequential training data set is used for additional training.

The first training node may transfer (or transmit) the second double-sided AI/ML training data information including the second reduced sequential training data set and the second sequential training data configuration information to the second training node. The second training node may receive the second double-sided AI/ML training data information including the second reduced sequential training data set and the second sequential training data configuration information from the first training node. The second training node may confirm that the second reduced sequential training data set is used for additional training based on the second sequential training data configuration information. The second training node may further include a step of performing additional training on the first double-sided AI/ML model using the second reduced sequential training data set.

In the additional training method in the sequential training method of the double-sided AI/ML model, steps S610 to S660 have been individually described, but this is not intended to limit an order in which the steps are performed, and when necessary, the respective steps may be performed simultaneously or in a different order, or at least some of the steps may be combined.

### Method 1-7

The second training node may receive the first reduced sequential training data from the first training node. After the first reduced sequential training data is received, the second training node may perform training using the first reduced training data set. The second training node may evaluate performance of the trained double-sided AI/ML model. A performance value according to the double-sided AI/ML model training in the second training node may be compared with a performance value according to the double-sided AI/ML model training in the first training. If the performance value according to the double-sided AI/ML model training in the second training node is lower than the performance value according to the AI/ML model training in the first training node, the second training node may transmit additional training request information requesting additional training to the first training node. The additional training request information may include at least one of the following.
Samples of channel information requiring additional training; or
A performance value of channel information requiring additional training.

The first training node may generate (or configure) the second reduced sequential training data set based on the request information of the second training data received from the second training node. After the second training data is generated (or configured), the first training node may transfer (or transmit) the second reduced training data to the second training node.

In Method 1-7, the following steps may be performed:

In step S1-7-1, the second training node may transmit an additional training request requesting additional training on the double-sided AI/ML model to the first training node. The first training node may receive the additional training request requesting additional training on the double-sided AI/ML model from the second training node.

Information of the additional training request may include at least one of a sample of channel information requiring additional training or a performance value of the channel information requiring additional training.

In step S1-7-2, the first training node may generate (or configure) a reduced sequential training data set for additional training based on the additional training request received in step S1-7-1.

In step S1-7-3, the first training node may transmit double-sided AI/ML training data information including the reduced sequential training data set for additional training and/or sequential training data configuration information generated (or configured) in step S1-7-2 to the second training node. The second training node may receive the double-sided AI/ML training data information including the reduced sequential training data set for additional training and/or sequential training data configuration information from the first training node. The sequential training data configuration information may include information indicating that the reduced sequential training data set is used for additional training

In step S1-7-4, the second training node may perform additional training on the double-sided AI/ML model according to the double-sided AI/ML training data information received in step S1-7-3.

In an exemplary embodiment, the first training node may transfer (transmit) the double-sided AI/ML training data information including the reduced sequential training data set for additional training and the sequential training data configuration information to the second training node. The second training node may receive the double-sided AI/ML training data information including the reduced sequential training data set for additional training and the sequential training data configuration information from the first training node.

The second training node may use the sequential training data configuration information received in step S1-7-3 to confirm that the reduced sequential training data set received in step S1-7-3 is used for additional training. If the received reduced sequential training data set is confirmed, the second training node may use the received reduced sequential training data set to perform additional training on the double-sided AI/ML model. The reduced sequential training data set and the sequential training data configuration information received in step S1-7-3 may be included in the double-sided AI/ML training data information received in step S1-7-3.

In Method 1-7, steps S1-7-1 to S1-7-4 have been described individually, but this is not intended to limit an order in which the steps are performed, and when necessary, the respective steps may be performed simultaneously or in a different order, or at least some of the steps may be combined.

### Method 1-8

The second training node may receive sequential training data from the first training node. After the sequential training data is received, the second training node may perform the same training process as in the first training node using only channel information of each sample. The second training node may perform training with mapping information having better performance than a performance value according to the model and training result of the first training node. In this case, the second training node may change the mapping information of the sequential training data. The second training node may transfer the changed mapping information of the sequential training data to the first training node.

In an exemplary embodiment, the first training node may transfer (or transmit) a non-reduced sequential training data to the second training node. After the non-reduced sequential training data is received, the second training node may perform new training using only the channel information. The second training node may compare a performance value according to the new training with a performance value according to the training of the first training node. If the performance value according to the new training is higher than the performance value according to the training of the first training node, the second training node may change mapping information in the non-reduced sequential training data. The second training node may transfer the changed mapping information to the first training node. The first training node may receive the changed mapping information from the second training node. The first training node may perform training again using the changed mapping information.

In Method 1-8, the following steps may be performed.

In step S1-8-1, the first training node may transmit double-sided AI/ML training data information including at least one of the sequential training data set or sequential training data configuration information to the second training node. The second training node may receive the double-sided AI/ML training data information including at least one of the sequential training data set or sequential training data configuration information from the first training node.

The sequential training data set may be the non-reduced sequential training data set. For example, the sequential training data set may be generated in step S320 illustrated in FIG. 3.

In step S1-8-2, the second training node may perform training on the double-sided AI/ML model using the sequential training data set received from the first training node in step S1-8-1.

In step S1-8-3, the second training node may change mapping information for the sequential training data set according to a result of training the two-sided AI/ML model in step S1-8-2.

In step S1-8-4, the second training node may transmit mapping change indication information indicating that the mapping information for the sequential training data set received from the first training node in step S1-8-1 has been changed to the first training node. The first training node may receive the mapping change indication information indicating that the mapping information for the sequential training data set has been changed from the second training node.

The first training node may confirm that the mapping information for the sequential training data set used for training the double-sided AI/ML model has been changed in the second training node according to the mapping change indication information received in step S1-8-4.

In an exemplary embodiment, the first training node may obtain a performance value (hereinafter, ‘first performance value’) according to a result of training the double-sided AI/ML model using the sequential training data set. The second training node may obtain a performance value (hereinafter, ‘second performance value’) according to a result of training the double-sided AI/ML model using the sequential training data set received from the first training node. When the second training node performs training on the double-sided AI/ML model using the sequential training data set received from the first training node, the second training node may perform training on the double-sided AI/ML model using only the channel information of the sequential training data set. The sequential training data set received from the first training node may include a plurality of sequential training data. It may be assumed that the second training node receives the first performance value from the first training node.

The second training node may compare the first performance value and the second performance value. If the first performance value is lower than the second performance value, the second training node may change the mapping information for the sequential data set received from the first training node. The second training node may transmit mapping change indication information indicating that the mapping change information for the sequential training data set has been changed to the first training node.

The first training node may receive the mapping change indication information indicating that the mapping change information for the sequential training data set has been changed from the second training node. When the mapping change indication information is received, the first training node may perform training on the double-sided AI/ML model again using the sequential training data set according to the mapping change indication information.

In Method 1-8, steps S1-8-1 to S1-8-4 have been described individually, but this is not intended to limit an order in which the steps are performed, and when necessary, the respective steps may be performed simultaneously or in a different order, or at least some of the steps may be combined.

### Method 1-9

After the sequential training data set is received from the first training node, the second training node may perform a reduction process on the sequential training data set on its own to generate (or configure) a reduced sequential training data set. The second training node may perform training on the two-sided AI/ML model using the reduced sequential training data set. The second training node may transfer (or transmit) reduction scheme information indicating the reduction scheme applied to the sequential training data set to the first training node.

In Method 1-9, the following steps may be performed.

In step S1-9-1, the first training node may transfer (or transmit) double-sided AI/ML training data information including at least one of the sequential training data set or sequential training data configuration information. The second training node may receive the double-sided AI/ML training data information including at least one of the sequential training data set or sequential training data configuration information from the second training node. The second training node may perform step S1-9-2 to generate (or configure) the reduced sequential training data set.

In step S1-9-3, the second training node may perform a reduction process on the sequential training data set received in step S1-9-1 to generate (or configure) the reduced sequential training data set.

In order to generate (or configure) the reduced sequential training data set in the reduction process, the second training node may apply a reduction scheme. The reduction scheme may include at least one of the random sampling-based reduction scheme, density-based reduction scheme of channel information, density-based reduction scheme of mapping information, or model-based importance-driven reduction scheme.

In step S1-9-4, the second training node may transmit reduction scheme information indicating the reduction scheme applied to generate (or configure) the reduced sequential data set in step S1-9-3 to the first training node. The first training node may receive the reduction scheme information from the second training node.

In Method 1-9, steps S1-9-1 to S1-9-3 have been described individually, but this is not intended to limit an order in which the steps are performed, and when necessary, the respective steps may be performed simultaneously or in a different order, or at least some of the steps may be combined.

### Efficient Model Information Transfer Method for Sequential Training

### Method 2

In the present disclosure, in the sequential training process for the double-sided AI/ML model, it may be proposed to transfer (or transmit) information on a double-sided AI/ML model defined by the first training node to the second training node. The double-sided AI/ML model may include an encoder model and/or a decoder model. Information on the double-sided AI/ML model defined by the first training node may include information related to the encoder model and/or the decoder model.

The first training node may define the double-sided AI/ML model information and transfer (or transmit) the double-sided AI/ML model information to the second training node. The second training node may generate (or configure) an double-sided AI/ML model based on the double-sided AI/ML model information defined by the first training node.

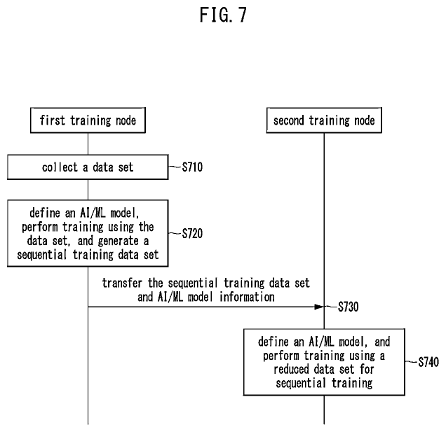

FIG. 7 is a sequence chart illustrating a double-sided AI/ML model information transmission method according to exemplary embodiments of the present disclosure.

Referring to FIG. 7, the communication system may include the first training node and the second training node. The first training node may define a double-sided AI/ML model and transfer (or transmit) information on the defined double-sided AI/ML model to the second training node. The second training node may configure (or obtain) a double-sided AI/ML model based on the double-sided AI/ML model information received from the first training node and perform training. The first training node may be the first training node 310 illustrated in FIG. 3, and the second training node may be the second training node 320 illustrated in FIG. 3. The double-sided AI/ML model may refer to a double-sided AI/ML model for CSI feedback. The double-sided AI/ML model may include an encoder model and/or a decoder model.

In step S710, the first training node may collect a data set for AI/ML model training. The collected data set may include multiple raw training data. The collected data set may be referred to as a raw training data set. The AI/ML model may refer to a double-sided AI/ML model for CSI feedback.

In step S720, the first training node may define an AI/ML model. Using the data set collected in step S710, the first training node may perform training on the AI/ML model. The first training node may generate (or obtain) a data set for sequential training for the AI/ML model. The data set for sequential training may be referred to as a sequential training data set, and data for sequential training may be referred to as sequential training data. The sequential training data set may include multiple sequential training data.

In step S730, the first training node may transfer (transmit) the data set for sequency training and the AI/ML model information generated (or obtained) in step S720 to the second training node. The second training node may receive the data set for sequential training and the AI/ML model information from the first training node.

As described above, the double-sided AI/ML model information defined by the first training node may include information related to the encoder model and/or the decoder model. The double-sided AI/ML model information defined by the first training node may include at least one of the following.
Type of backbone artificial neural network;
Type of input data;
Size of input data;
Type of output data;
Size of output data;
Amount of computation;
Number of artificial neural network parameters;
Size of storage space;
Quantization scheme of artificial neural network parameters;
Artificial neural network parameters;
Pre-trained parameters, or final trained parameters.
Training data identifier; or
Information related to the performance of the artificial neural network.

In step S740, the second training node may define an AI/ML model. The second training node may perform a reduction process on the sequential training data set based on the AI/ML model information to generate (or configure) a reduced sequential training data set. The second training node may perform training on the AI/ML model by using the reduced sequential training data set. The AI/ML model information may be the AI/ML model information received in step S720, and the sequential training data set may be the sequential training data set received in step S720. As described above, the AI/ML model may refer to a double-sided AI/ML model for CSI feedback.

The reduced sequential training data set may include multiple sequential training data. The sequential training data may include a pair of channel information and mapping information for the channel information. The mapping information may be determined according to a result of AI/ML training in the second training node (e.g. terminal).

The above-described model information transmission method may further include a step (hereinafter, ‘feedback transmission step’) in which the second training node transmits CSI feedback information after step S740 is performed.

In the feedback transmission step, the second training node may transmit CSI feedback information to the first training node based on the AI/ML model trained in step S740. The first training node may receive the CSI feedback information based on the AI/ML model from the second training node.

For convenience of description, the first training node may collect the data set for sequential training on the double-sided AI/ML model for CSI feedback in step S710, but is not limited thereto.

The first training node may define the double-sided AI/ML model for CSI feedback in step S720, but is not limited thereto.

The second training node may define the double-sided AI/ML model for CSI feedback in step S740, but is not limited thereto.

In an exemplary embodiment, in the double-sided AI/ML model information transmission method illustrated in FIG. 7, it may be assumed that collection of the data set in the first training node has been completed. It may be assumed that the AI/ML model in the first training node and the AI/ML model in the second training node are predefined. As described above, the AI/ML model may refer to a double-sided AI/ML model for CSI feedback. The double-sided AI/ML model may include an encoder model and/or a decoder model.

In the model information transmission method, steps S710 to S740 have been individually described, but this is not intended to limit an order in which the steps are performed, and when necessary, the respective steps may be performed simultaneously or in a different order, or at least some of the steps may be combined.

In an exemplary embodiment of the present disclosure, the base station and the terminal may sequentially train the double-sided AI/ML model for CSI feedback. The first training node may be assumed to be the base station, and the second training node may be assumed to be the terminal.

### Method 2-1

The first training node may define a double-sided AI/ML model. Information on the double-sided AI/ML model defined by the first training node may include one or more encoder model information and/or decoder model information. The second training node may transfer (or transmit) a double-sided AI/ML model request requesting the double-sided AI/ML model information defined by the first training node to the first training node. The second training node may configure (or generate) a double-sided AI/ML model based on the double-sided AI/ML model information received from the first training node, and may perform training on the double-sided AI/ML model.

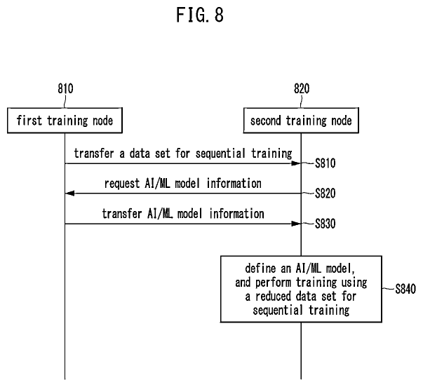

FIG. 8 is a sequence chart illustrating a method for transmitting double-sided AI/ML model information based on a request according to exemplary embodiments of the present disclosure.

Referring to FIG. 8, the communication system may include the first training node and the second training node. The first training node may define an AI/ML model. The first training node may transfer (or transmit) information on the AI/ML model to the second training node according to a request of the second training node. The first training node may be the first training node 310 illustrated in FIG. 3, and the second training node may be the second training node 320 illustrated in FIG. 3. It may be assumed that information on the AI/ML model is defined in the first training node. As described above, the AI/ML model may refer to a double-sided AI/ML model for CSI feedback. The two-sided AI/ML model may include an encoder model and/or a decoder model.

In step S810, the first training node may transfer (or transmit) a data set for sequential training to the second training node. The second training node may receive the data set for sequential training from the first training node. As described above, the data set for sequential training may be referred to as the sequential training data set, and data for sequential training may be referred to as sequential training data. The sequential training data set may include multiple sequential training data.

When the second training node performs step S810 to receive the sequential training data set, the second training node may perform step S820 to request AI/ML model information from the first training node.

In step S820, the second training node may transfer (or transmit) an AI/ML model request requesting AI/ML model information defined by the first training node to the first training node. The first training node may receive the AI/ML model request from the second training node.

In step S830, the first training node may transfer (or transmit) the AI/ML model information to the first training node in response to the AI/ML model request received from the second training node in step S820. The second training node may receive the AI/ML model information from the first training node.

When the second training node performs step S840 to receive the AI/ML model information, the second training node may perform step S840 to configure (or generate) an AI/ML model based on the AI/ML model information and perform training on the AI/ML model.

In step S840, the second training node may perform a reduction process on the sequential training data set based on the AI/ML model information to generate (or configure) a reduced sequential training data set. The second training node may perform training for the AI/ML model using the reduced sequential training data set. The AI/ML model information may be the AI/ML model information received in step S830, and the sequential training data set may be the sequential training data set received in step S810. As described above, the AI/ML model may refer to a double-sided AI/ML model for CSI feedback.

As described above, the reduced sequential training data set may include multiple sequential training data. The sequential training data may include a pair of channel information and mapping information for the channel information. The mapping information may be determined based on a result of AI/ML training in the second training node (e.g. terminal).

The above-described request-based method for transmitting AI/ML model information may further include a step in which the second training node transmits CSI feedback information after step S840 is performed.

In the step in which the second training node transmits CSI feedback information, the second training node may transmit the CSI feedback information to the first training node based on the AI/ML model trained in step S740. The first training node may receive the CSI feedback information based on the AI/ML model from the second training node.

In the request-based method for transmitting AI/ML model information, steps S810 to S840 have been described individually, but this is not intended to limit an order in which the steps are performed, and when necessary, the respective steps may be performed simultaneously or in a different order, or at least some of the steps may be combined.

### Method 2-2

In the sequential training process for the two-sided AI/ML model, the second training node may define two-sided AI/ML model information. The double-sided AI/ML model information defined by the second training node may include one or more encoder model information and/or decoder model information. The double-sided AI/ML model information defined by the second training node may be transferred (or transmitted) to the first training node. The first training node may determine a double-sided AI/ML model in the first training node based on the double-sided AI/ML model information defined by the second training node. The first training node may perform training using the determined double-sided AI/ML model. Then, the first training node may configure (or generate) a training data set for sequential training.

As described above, the data set for sequential training may be referred to as the sequential training data set, and data for sequential training may be referred to as sequential training data. The sequential training data set may include multiple sequential training data.

In Method 2-2, the following steps may be performed.

In step S2-2-1, the second training node may define double-sided AI/ML model information. The second training node may define the double-sided AI/ML model information according to a predetermined scheme. The double-sided AI/ML model information defined by the second training node may include one or more encoder model information and/or decoder model information. The second training node may perform step S2-2-2 to transmit the defined double-sided AI/ML model information to the first training node.

In step S2-2-2, the second training node may transmit the double-sided AI/ML model information defined in step S2-2-1 to the first training node. The first training node may receive the double-sided AI/ML model information from the second training node. The first training node may perform step S2-2-3.

In step S2-2-3, the first training node may determine a double-sided AI/ML model based on the double-sided AI/ML model information received from the second training node in step S2-2-2. The first training node may perform training on the double-sided AI/ML model determined in step S2-2-3 in step S2-2-4. The first training node may perform step S2-2-4.

In step S2-2-4, the first training node may configure (or generate) a sequential training data set for the double-sided AI/ML model trained in step S2-2-3.

In Method 2-2, steps S2-2-1 to S2-2-4 have been described individually, but this is not intended to limit an order in which the steps are performed, and when necessary, the respective steps may be performed simultaneously or in a different order, or at least some of the steps may be combined.

### Method 2-4

In the sequential training process for the double-sided AI/ML model, the double-sided AI/ML model information may be stored in a separate server. The double-sided AI/ML model information stored in the separate server may be identified according to a model identifier (ID). The first training node and the second training node may transmit and receive the double-sided AI/ML model information using the model ID.

The operations of the method according to the exemplary embodiment of the present disclosure can be implemented as a computer readable program or code in a computer readable recording medium. The computer readable recording medium may include all kinds of recording apparatus for storing data which can be read by a computer system. Furthermore, the computer readable recording medium may store and execute programs or codes which can be distributed in computer systems connected through a network and read through computers in a distributed manner.

The computer readable recording medium may include a hardware apparatus which is specifically configured to store and execute a program command, such as a ROM, RAM or flash memory. The program command may include not only machine language codes created by a compiler, but also high-level language codes which can be executed by a computer using an interpreter.

Although some aspects of the present disclosure have been described in the context of the apparatus, the aspects may indicate the corresponding descriptions according to the method, and the blocks or apparatus may correspond to the steps of the method or the features of the steps. Similarly, the aspects described in the context of the method may be expressed as the features of the corresponding blocks or items or the corresponding apparatus. Some or all of the steps of the method may be executed by (or using) a hardware apparatus such as a microprocessor, a programmable computer or an electronic circuit. In some embodiments, one or more of the most important steps of the method may be executed by such an apparatus.

In some exemplary embodiments, a programmable logic device such as a field-programmable gate array may be used to perform some or all of functions of the methods described herein. In some exemplary embodiments, the field-programmable gate array may be operated with a microprocessor to perform one of the methods described herein. In general, the methods are preferably performed by a certain hardware device.

The description of the disclosure is merely exemplary in nature and, thus, variations that do not depart from the substance of the disclosure are intended to be within the scope of the disclosure. Such variations are not to be regarded as a departure from the spirit and scope of the disclosure. Thus, it will be understood by those of ordinary skill in the art that various changes in form and details may be made without departing from the spirit and scope as defined by the following claims.

What is claimed is:

1. A method of a first training node, comprising:
performing training on a first two-sided artificial intelligence/machine learning (AI/ML) model using a raw training data set collected for channel state information (CSI) feedback;
generating a sequential training data set for sequential training on the first two-sided AI/ML model;
performing pruning on the sequential training data set to obtain a reduced sequential training data set; and
transmitting, to a second training node, two-sided AI/ML training data information including at least one of the reduced sequential training data set or sequential training data configuration information,
wherein the raw training data set includes multiple raw training data, the raw training data includes at least one of channel information, cell information, region information, or signal-to-noise ratio (SNR) information, each of the sequential training data set and the reduced sequential training data set includes multiple sequential training data, the sequential training data includes a pair of the channel information and mapping information for the channel information, and the channel information is a channel matrix or a precoding vector.

2. The method according to claim 1, wherein the first double-sided AI/ML model includes at least one of a first encoder model or a first decoder model, and when the first training node is a base station, the first encoder model is not used in a CSI feedback operation, and the CSI feedback corresponds to inference in the first training node.

3. The method according to claim 1, wherein the sequential training data configuration information includes at least one of a number of samples of the raw training data, additional information of the raw training data, a number of samples of the sequential training data, a reduction ratio of a number of the sequential training data, a type of the channel information, whether or not the channel information is quantized and a quantization scheme of the channel information, a quantization scheme of the mapping information, or a performance value according to the model and training of the first training node.

4. The method according to claim 1, wherein the sequential training data configuration information includes information on a reduction scheme of the sequential training data, and the reduction scheme includes at least one of a random sampling-based reduction scheme, a density-based reduction scheme of channel information, a density-based reduction scheme of mapping information, or a model-based importance-driven reduction scheme.

5. The method according to claim 1, wherein the sequential training data configuration information includes at least one information of importance information or density information for each sample of the sequential training data for the sequential training, and the at least one information is determined according to a scheme of reducing the sequential training data for the sequential training.

6. The method according to claim 1, further comprising: receiving, from the second training node, first indication information indicating that data augmentation has been applied,
wherein the first indication information includes information related to a scheme applied to the data augmentation, the scheme is at least one of a noise-addition scheme, a rotation scheme, or a generative AI model scheme, and the scheme is considered for training on the first double-sided AI/ML model.

7. The method according to claim 6, wherein when the second node is confirmed to have applied data augmentation according to the first indication information, the first training node performs new training or additional training on the first double-sided AI/ML model by applying the scheme.

8. The method according to claim 1, further comprising, after the reduced sequential training data set is transferred to the second training node,
generating a second reduced sequential training data set for additional training; and
transmitting, to the second training node, second double-sided AI/ML training data information including at least one of the second reduced sequential training data set or second sequential training data configuration information,
wherein the second sequential training data configuration information includes information indicating that the second reduced sequential training data set is used for additional training.

9. The method according to claim 1, further comprising:
receiving, from the second training node, an additional training request requesting additional training;
generating a second reduced sequential training data set based on the additional training request; and
in response to the additional training request, transmitting, to the second training node, second double-sided AI/ML training data information including at least one of the second reduced sequential training data set or second sequential training data configuration information,
wherein the additional training request includes at least one of a sample of channel information requiring additional training or a performance value of channel information requiring additional training, and the second sequential training data configuration information includes information indicating that the second reduced sequential training data set is used for additional training.

10. The method according to claim 1, further comprising:
transmitting, to the second training node, double-sided AI/ML training data information including at least one of the sequential training data set or the sequential training data configuration information; and
receiving, from the second learning node, mapping change indication information indicating that mapping information has been changed for the sequential training data set,
wherein when a first performance according to a result of training the first double-sided AI/ML model is lower than a second performance according to a result of training a double-sided AI/ML model in the second training node, the change indication information is received from the second training node, and training on the first double-sided AI/ML model is performed using the sequential training data set.

11. The method according to claim 1, further comprising:
transmitting, to the second training node, double-sided AI/ML training data information including at least one of the sequential training data set or the sequential training data configuration information; and
receiving, from the second learning node, reduction scheme information indicating a reduction scheme applied to the sequential training data set,
wherein the reduction scheme includes at least one of a random sampling-based reduction scheme, a density-based reduction scheme of channel information, a density-based reduction scheme of mapping information, or a model-based importance-driven reduction scheme.

12. A method of a second training node, comprising:
receiving, from a first training node, two-sided artificial intelligence/machine learning (AI/ML) training data information including a reduced sequential training data set;
performing sequential training on a two-sided AI/ML model for channel state information (CSI) feedback using the reduced sequential training data set; and
transmitting CSI feedback information to the first training node based on the two-sided AI/ML model,
wherein the two-sided AI/ML model includes at least one of an encoder model and a decoder model, the reduced sequential training data set includes multiple sequential training data, each of the multiple sequential training data includes a pair of channel information and mapping information for the channel information, the channel information includes at least one sample, and the channel information is expressed as a channel matrix or a precoding vector.

13. The method according to claim 12, further comprising: in response to the second training node determining to apply data augmentation, transmitting, to the first training node, first indication information indicating that the data augmentation is applied,
wherein the first double-sided AI/ML model is trained by applying the data augmentation before the first indication information is transmitted to the first training node, the first indication information includes at least one of information indicating whether the data augmentation is applied in the second training node, information indicating that the second training node has determined the data augmentation, or information indicating a scheme applied to the data augmentation, and the scheme applied to the data augmentation is at least one of a noise-addition scheme, a rotation scheme, or a scheme of using a generative AI model.

14. The method according to claim 12, further comprising:
receiving, from the first training node, second double-sided AI/ML training data information including at least one of a second reduced sequential training data set for additional training or second sequential training data configuration information; and
performing additional training on the double-sided AI/ML model using the second reduced sequential training data set,
wherein the second sequential training configuration information includes information indicating that the second reduced sequential training data set is used for additional training.

15. The method according to claim 12, further comprising:
transmitting, to the first training node, an additional training request requesting additional training on the double-sided AI/ML model;
in response to the additional training request, receiving second double-sided AI/ML training data information including at least one of a second reduced sequential training data set or second sequential training configuration information; and
performing the additional training on the double-sided AI/ML model using the second reduced sequential training data set,
wherein the additional training request includes at least one of a sample of channel information requiring additional training or a performance value of channel information requiring additional training, and the second sequential training data configuration information includes information indicating that the second reduced sequential training data set is used for additional training.

16. The method according to claim 15, wherein the transmitting of the additional training request to the first training node comprises: comparing a first performance of training the double-sided AI/ML model in the first training node with a second performance of training the double-sided AI/ML model in the second training node,
wherein the additional training request is transmitted to the first training node when the second performance is lower than the first performance.

17. The method according to claim 12, further comprising:
receiving, from the first training node, double-sided AI/ML training data information including at least one of a sequential training data set or sequential training data configuration information;
performing training on the double-sided AI/ML model using the sequential training data set;
performing mapping information change on the sequential training data set according to a result of the training on the double-sided AI/ML model; and
transmitting, to the first training node, mapping change indication information indicating that mapping information has been changed for the sequential training data set,
wherein when a first performance is lower than a second performance, the mapping change indication information is transmitted to the first training node, and the first performance is a performance according to a result of training the double-sided AI/ML model in the first training node, and the second performance is a performance according to a result of training the double-sided AI/ML model in the second training node.

18. The method according to claim 14, further comprising:
receiving, from the first training node, double-sided AI/ML training data information including at least one of a sequential training data set or sequential training data configuration information;
performing a reduction process on the sequential training data set to generate a reduced sequential training data set;
performing second sequential training on the double-sided AI/ML model using the reduced sequential training data set; and
transmitting, to the first training node, reduction scheme information indicating a reduction scheme applied to the sequential training data set,
wherein the reduction scheme includes at least one of a random sampling-based reduction scheme, a density-based reduction scheme of channel information, a density-based reduction scheme of mapping information, or a model-based importance-driven reduction scheme.

19. A first training node comprising at least one processor, wherein the at least one processor causes the first training node to perform:
performing training on a first two-sided artificial intelligence/machine learning (AI/ML) model using a raw training data set collected for channel state information (CSI) feedback;
generating a sequential training data set for sequential training on the first two-sided AI/ML model; and
transmitting the sequential training data set and information on the first two-sided AI/ML model to a second training node,
wherein the information on the first two-sided AI/ML model includes at least one of encoder model-related information or decoder model-related information.

20. The first training node according to claim 19, wherein information on the first two-sided AI/ML model includes at least one of a type of a backbone artificial neural network, a type of input data, a size of input data, a type of output data, a size of output data, amount of computation, a number of artificial neural network parameters, a size of storage space, a quantization scheme of artificial neural network parameters, artificial neural network parameters, training data identifier, or information related to performance of artificial neural networks.
